(19) United States
(12) Patent Application Publication
(10) Pub. No.: US 2024/0140491 A1
(43) Pub. Date: May 2, 2024

(54) Automated Delivery System, Method, and Computer Program Product

(71) Applicant: Argo AI, LLC, Pittsburgh, PA (US)

(72) Inventor: Michel Laverne, Pittsburgh, PA (US)

(21) Appl. No.: 17/977,593

(22) Filed: Oct. 31, 2022

(51) Int. Cl. B60W 60/00; B60R 25/24; G06Q 10/08

(52) U.S. Cl. CPC B60W 60/00256; B60R 25/24; G06Q 10/08355; B60W 2420/42

(57) ABSTRACT

Disclosed herein are methods, systems, and computer program products for automated delivery of goods that include: a deployment vehicle; and an autonomous delivery vehicle contained within the deployment vehicle, where the delivery vehicle secures a package, where the delivery vehicle is programmed or configured to: deploy the delivery vehicle from the deployment vehicle; autonomously navigate the delivery vehicle from the deployment vehicle to a delivery location; park the delivery vehicle at the delivery location; and in response to an authorization protocol being satisfied, release the package.

### BACKGROUND

### 1. Field

This disclosure relates generally to delivery of goods and, in some non-limiting embodiments or aspects, methods, systems, and computer program products for automated delivery of goods to a delivery location.

### 2. Technical Considerations

Delivering a good from the manufacturer's location to the customer can involve multiple steps. For example, in a first step, the good may be transported from the manufacturer location to one or more hubs, such that the good arrives at a local distribution hub. From the local distribution hub, the good may then be transported to the customer's delivery location. This final step of the delivery from the local distribution hub to the customer's delivery location, can be broken down into the following substeps: (1) transporting the goods from the local hub to a region proximate the customer's delivery location (e.g., such as a block or street); and (2) transporting the goods from the proximate region to the specific delivery location (e.g., the customer's mailbox or doorstep). The transport of goods from the proximate region to the specific delivery location is sometimes referred to as the “last foot” of the delivery process.

### SUMMARY

In the context of automated delivery, autonomous ground vehicles (e.g. cars, vans, etc.) can efficiently travel short/medium distances, but are far less efficient in successfully addressing the “last foot” of the delivery process. The present disclosure is directed to methods, systems, and computer program products for delivery of goods in a manner that can better address the “last foot” of the delivery process.

According to some non-limiting embodiments or aspects, a system includes a deployment vehicle; and an autonomous delivery vehicle contained within the deployment vehicle, where the delivery vehicle is adapted to secure a package therein, where the delivery vehicle is programmed or configured to: deploy from the deployment vehicle; autonomously navigate from the deployment vehicle to a delivery location; park at the delivery location; and in response to an authorization protocol being satisfied, release the package.

According to some non-limiting embodiments or aspects, a method includes deploying a deployment vehicle from a first location to a deployment location, where the deployment location is closer to a delivery location than the first location, where the deployment vehicle contains an autonomous delivery vehicle, where the delivery vehicle secures a package therein; deploying the delivery vehicle from the deployment vehicle; autonomously navigating the delivery vehicle from the deployment vehicle to the delivery location; parking the delivery vehicle at the delivery location; and in response to an authorization protocol being satisfied, releasing the package from the delivery vehicle.

According to some non-limiting embodiments or aspects, a computer program product includes at least one non-transitory computer-readable medium including one or more instructions that, when executed by at least one processor, cause the at least one processor to: deploy an autonomous delivery vehicle from a deployment vehicle, where the delivery vehicle is arranged within the deployment vehicle, where the delivery vehicle secures a package; autonomously navigate the delivery vehicle from the deployment vehicle to a delivery destination; park the delivery vehicle at the delivery destination; and in response to an authorization protocol being satisfied, release the package.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic drawing of an exemplary autonomous vehicle system according to non-limiting embodiments or aspects;

FIG. 2 is a schematic drawing illustrating exemplary system architecture for an autonomous or semi-autonomous vehicle according to non-limiting embodiments or aspects;

FIG. 3 is an illustration of a illustrative architecture for a LiDAR system according to non-limiting embodiments or aspects;

FIG. 4 is a schematic drawing of a delivery system according to non-limiting embodiments or aspects;

FIG. 5 is a schematic drawing of a delivery system according to non-limiting embodiments or aspects;

FIG. 6A is a schematic drawing of a map of paths taken by delivery systems according to non-limiting embodiments or aspects;

FIG. 6B is a schematic drawing of a map of a path taken by a delivery system according to non-limiting embodiments or aspects;

FIG. 6C is a schematic drawing of the map of the path taken by a delivery system from FIG. 6B further including the path taken by a collection system according to non-limiting embodiments or aspects;

FIG. 7 is a schematic drawing of a map of paths taken by delivery vehicles according to non-limiting embodiments or aspects;

FIG. 8 is a schematic drawing of a delivery vehicle according to non-limiting embodiments or aspects;

FIG. 9A is a schematic drawing of a delivery vehicle in a secured position according to non-limiting embodiments or aspects;

FIG. 9B is a schematic drawing of the delivery vehicle of FIG. 9A in a released position according to non-limiting embodiments or aspects;

FIG. 10 is a schematic drawing of a delivery vehicle in a secured position according to non-limiting embodiments or aspects;

FIG. 11 is a schematic drawing of a delivery vehicle in a secured position according to non-limiting embodiments or aspects;

FIG. 12 is a step diagram of a method for automated delivery according to non-limiting embodiments or aspects; and

FIG. 13 is a schematic drawing of components of a computer system that can be used with an autonomous or semi-autonomous vehicle according to non-limiting embodiments or aspects.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions, and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is being described herein in the context of an autonomous vehicle. However, the present solution is not limited to autonomous vehicle applications. The present solution may be used in other applications such as robotic applications, radar system applications, metric applications, and/or system performance applications.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “server” and/or “processor” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or processor recited as performing a second step or function.

As used herein, the term “user interface” or “graphical user interface” may refer to a generated display, such as one or more graphical user interfaces (GUIs) with which a user may interact, either directly or indirectly (e.g., through a keyboard, mouse, touchscreen, etc.).

Non-limiting embodiments or aspects are directed to computer-implemented methods, systems, and computer program products for automated delivery of goods to a delivery location. Non-limiting embodiments or aspects include a deployment vehicle and an autonomous delivery vehicle contained within the deployment vehicle. The delivery vehicle may be deployed from the deployment vehicle and autonomously navigate to a delivery location using sensors. The delivery vehicle may secure the package being delivered at the delivery location and may release the package in response to an authorization protocol being satisfied, such that only the correct user(s) can retrieve the package. The delivery vehicle may also autonomously navigate from the delivery location to a collection location to be collected by a same or different deployment vehicle.

According to some non-limiting embodiments or aspects, a system includes: a deployment vehicle; and an autonomous delivery vehicle contained within the deployment vehicle, wherein the delivery vehicle is adapted to secure a package, wherein the delivery vehicle is programmed or configured to: deploy from the deployment vehicle; autonomously navigate from the deployment vehicle to a delivery location; park at the delivery location; and in response to an authorization protocol being satisfied, release the package.

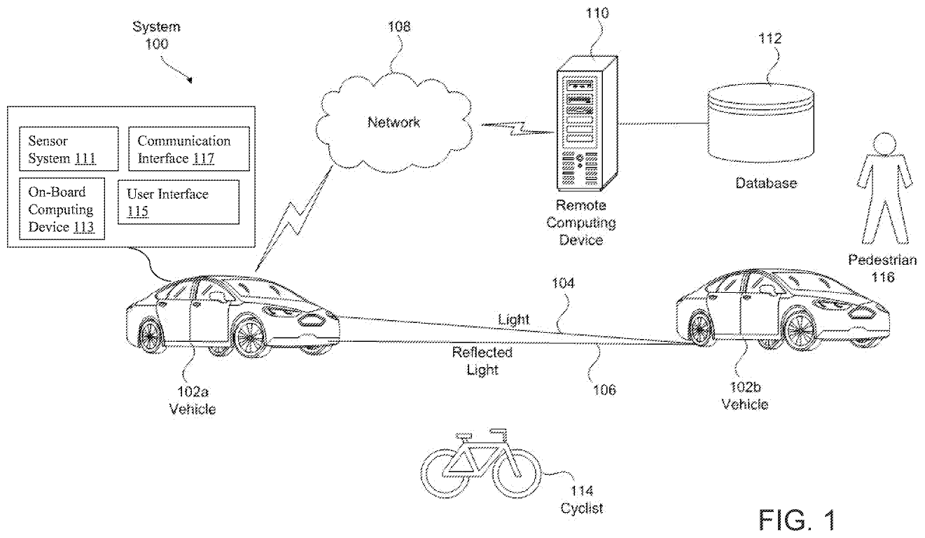

FIG. 1 illustrates an exemplary autonomous vehicle system 100, in accordance with aspects of the disclosure. System 100 comprises a vehicle 102a that is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

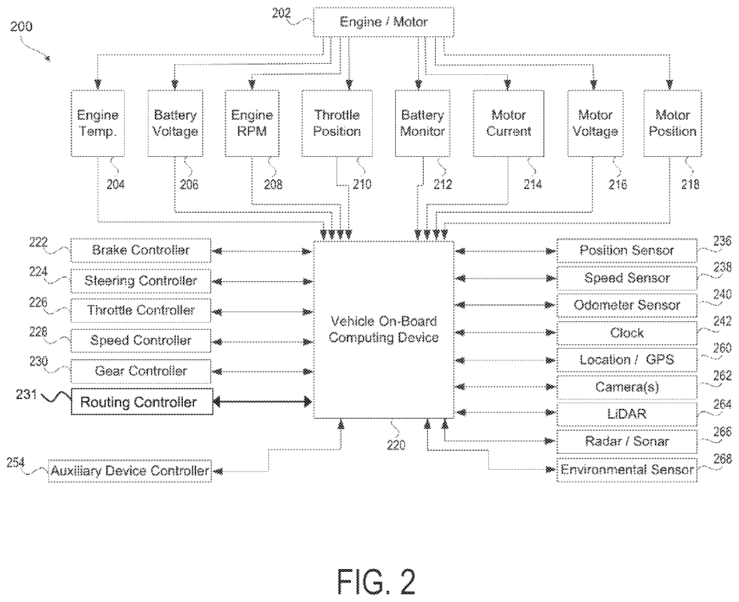

As illustrated in FIG. 1, the AV 102a may include a sensor system 111, an on-board computing device 113, a communications interface 117, and a user interface 115. AV 102a may further include certain components (as illustrated, for example, in FIG. 2) included in vehicles, which may be controlled by the on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a light detection and ranging (LiDAR) system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, AV 102a may be configured with a LiDAR system, e.g., LiDAR system 264 of FIG. 2. The LiDAR system may be configured to transmit a light pulse 104 to detect objects located within a distance or range of distances of AV 102a. Light pulse 104 may be incident on one or more objects (e.g., 102b) and be reflected back to the LiDAR system. Reflected light pulse 106 incident on the LiDAR system may be processed to determine a distance of that object to AV 102a. The reflected light pulse may be detected using, in some embodiments, a photodetector or array of photodetectors positioned and configured to receive the light reflected back into the LiDAR system. LiDAR information, such as detected object data, is communicated from the LiDAR system to an on-board computing device, e.g., on-board computing device 220 of FIG. 2. The AV 102a may also communicate LiDAR data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the LiDAR systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions or other configurations as is known.

The communications interface 117 may be configured to allow communication between AV 102a and external systems, such as, for example, external devices, sensors, other vehicles, servers, data stores, databases etc. The communications interface 117 may utilize any now or hereafter known protocols, protection schemes, encodings, formats, packaging, etc. such as, without limitation, Wi-Fi, an infrared link, Bluetooth, etc. The user interface 115 may be part of peripheral devices implemented within the AV 102a including, for example, a keyboard, a touch screen display device, a microphone, and a speaker, etc.

FIG. 2 illustrates an exemplary system architecture 200 for a vehicle, in accordance with aspects of the disclosure. Vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors, and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a LiDAR system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

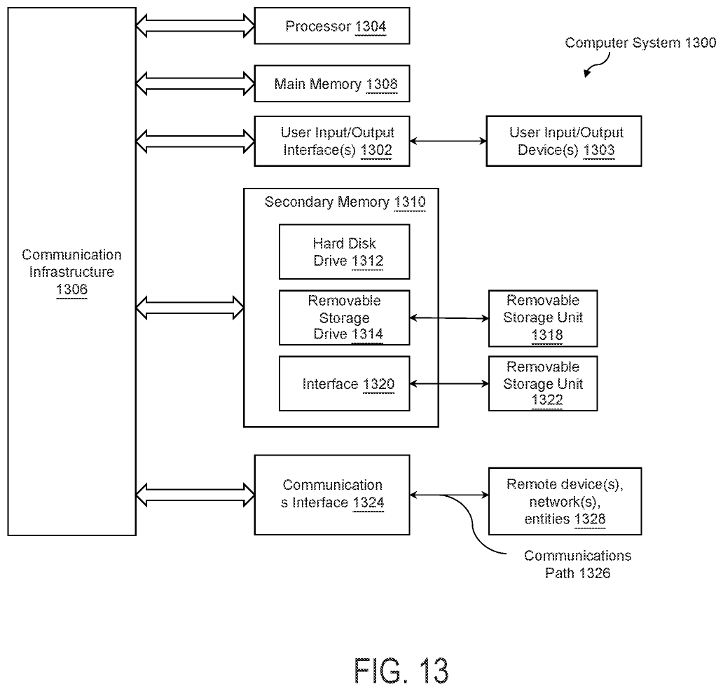

During operations, information is communicated from the sensors to a vehicle on-board computing device 220. The on-board computing device 220 may be implemented using the computer system of FIG. 13. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as LiDAR system 264 is communicated from those sensors to the on-board computing device 220. The object detection information and/or captured images are processed by the on-board computing device 220 to detect objects in proximity to the AV 102a. Any known or to be known technique for making an object detection based on sensor data and/or captured images can be used in the embodiments disclosed in this document.

LiDAR information is communicated from LiDAR system 264 to the on-board computing device 220. Additionally, captured images are communicated from the camera(s) 262 to the vehicle on-board computing device 220. The LiDAR information and/or captured images are processed by the vehicle on-board computing device 220 to detect objects in proximity to the AV 102a. The manner in which the object detections are made by the vehicle on-board computing device 220 includes such capabilities detailed in this disclosure.

The on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and identify a preferred route to reach the destination. For example, the routing controller 231 may generate a navigation route that minimizes Euclidean distance traveled or other cost function during the route, and may further access the traffic information and/or estimates that can affect an amount of time it will take to travel on a particular route. Depending on implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week or current time of day, etc.), such that a route generated for travel during rush-hour may differ from a route generated for travel late at night. The routing controller 231 may also generate more than one navigation route to a destination and send more than one of these navigation routes to a user for selection by the user from among various possible routes.

In various embodiments, the on-board computing device 220 may determine perception information of the surrounding environment of the AV 102a. Based on the sensor data provided by one or more sensors and location information that is obtained, the on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the on-board computing device 220 may process sensor data (e.g., LiDAR or RADAR data, camera images, etc.) in order to identify objects and/or features in the environment of AV 102a. The objects may include traffic signals, roadway boundaries, other vehicles, pedestrians, and/or obstacles, etc. The on-board computing device 220 may use any now or hereafter known object recognition algorithms, video tracking algorithms, and computer vision algorithms (e.g., track objects frame-to-frame iteratively over a number of time periods) to determine the perception.

In some embodiments, the on-board computing device 220 may also determine, for one or more identified objects in the environment, the current state of the object. The state information may include, without limitation, for each object: current location; current speed and/or acceleration; current heading; current pose; current shape, size, or footprint; type (e.g., vehicle vs. pedestrian vs. bicycle vs. static object or obstacle); and/or other state information.

The on-board computing device 220 may perform one or more prediction and/or forecasting operations. For example, the on-board computing device 220 may predict future locations, trajectories, and/or actions of one or more objects. For example, the on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing device 220 may predict whether the object will likely move straight forward or make a turn. If the perception data indicates that the intersection has no traffic light, the on-board computing device 220 may also predict whether the vehicle may have to fully stop prior to entering the intersection.

In various embodiments, the on-board computing device 220 may determine a motion plan for the autonomous vehicle. For example, the on-board computing device 220 may determine a motion plan for the autonomous vehicle based on the perception data and/or the prediction data. Specifically, given predictions about the future locations of proximate objects and other perception data, the on-board computing device 220 can determine a motion plan for the AV 102a that best navigates the autonomous vehicle relative to the objects at their future locations.

In some embodiments, the on-board computing device 220 may receive predictions and make a decision regarding how to handle objects and/or actors in the environment of the AV 102a. For example, for a particular actor (e.g., a vehicle with a given speed, direction, turning angle, etc.), the on-board computing device 220 decides whether to overtake, yield, stop, and/or pass based on, for example, traffic conditions, map data, state of the autonomous vehicle, etc. Furthermore, the on-board computing device 220 also plans a path for the AV 102a to travel on a given route, as well as driving parameters (e.g., distance, speed, and/or turning angle). That is, for a given object, the on-board computing device 220 decides what to do with the object and determines how to do it. For example, for a given object, the on-board computing device 220 may decide to pass the object and may determine whether to pass on the left side or right side of the object (including motion parameters such as speed). The on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers performed in a pre-defined time period (e.g., N milliseconds). If the collision can be avoided, then the on-board computing device 220 may execute one or more control instructions to perform a cautious maneuver (e.g., mildly slow down, accelerate, change lanes, or swerve). In contrast, if the collision cannot be avoided, then the on-board computing device 220 may execute one or more control instructions for execution of an emergency maneuver (e.g., brake and/or change direction of travel).

As discussed above, planning and control data regarding the movement of the autonomous vehicle is generated for execution. The on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

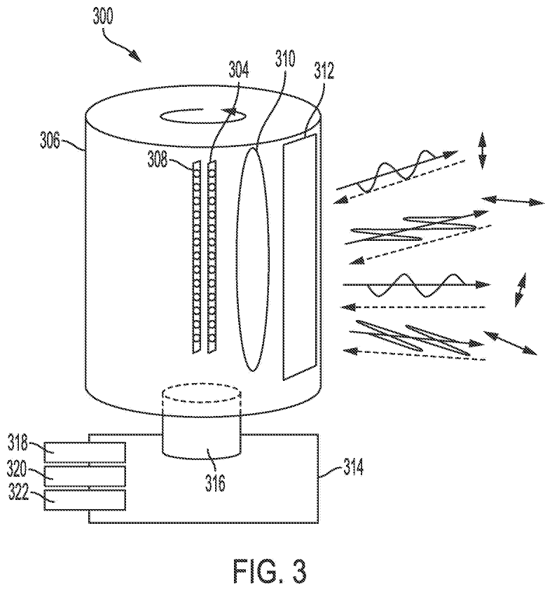

Referring now to FIG. 3, there is provided an illustration of an illustrative LiDAR system 300. LiDAR system 264 of FIG. 2 may be the same as or substantially similar to LiDAR system 300.

As shown in FIG. 3, LiDAR system 300 may include housing 306, which may be rotatable 360° about a central axis such as hub or axle 316. Housing 306 may include an emitter/receiver aperture 312 made of a material transparent to light. Although a single aperture is shown in FIG. 2, non-limiting embodiments or aspects of the present disclosure are not limited in this regard. In other scenarios, multiple apertures for emitting and/or receiving light may be provided. Either way, LiDAR system 300 can emit light through one or more of aperture(s) 312 and receive reflected light back toward one or more of aperture(s) 312 as housing 306 rotates around the internal components. In alternative scenarios, the outer shell of housing 306 may be a stationary dome, at least partially made of a material that is transparent to light, with rotatable components inside of housing 306.

Inside the rotating shell or stationary dome is a light emitter system 304 that is configured and positioned to generate and emit pulses of light through aperture 312 or through the transparent dome of housing 306 via one or more laser emitter chips or other light emitting devices. Emitter system 304 may include any number of individual emitters (e.g., 8 emitters, 64 emitters, 128 emitters, etc.). The emitters may emit light of substantially the same intensity or of varying intensities. The individual beams emitted by light emitter system 304 may have a well-defined state of polarization that is not the same across the entire array. As an example, some beams may have vertical polarization and other beams may have horizontal polarization. LiDAR system 300 may include light detector 308 containing a photodetector or array of photodetectors positioned and configured to receive light reflected back into the system. Emitter system 304 and light detector 308 may rotate with the rotating shell, or emitter system 304 and light detector 308 may rotate inside the stationary dome of housing 306. One or more optical element structures 310 may be positioned in front of light emitting system 304 and/or light detector 308 to serve as one or more lenses and/or waveplates that focus and direct light that is passed through optical element structure 310.

One or more optical element structures 310 may be positioned in front of mirror (not shown) to focus and direct light that is passed through optical element structure 310. As shown in FIG. 3, the system includes optical element structure 310 positioned in front of the mirror and connected to the rotating elements of the system so that optical element structure 310 rotates with mirror. Alternatively or in addition, optical element structure 310 may include multiple such structures (for example lenses and/or waveplates). Optionally, multiple optical element structures 310 may be arranged in an array on or integral with the shell portion of the housing 306.

In some non-limiting embodiments or aspects, each optical element structure 310 may include a beam splitter that separates light that the system receives from light that the system generates. The beam splitter may include, for example, a quarter-wave or half-wave waveplate to perform the separation and ensure that received light is directed to the receiver unit rather than to the emitter system (which could occur without such a waveplate as the emitted light and received light should exhibit the same or similar polarizations).

LiDAR system 300 may include power unit 318 to power the light emitting system 304, central hub or axle 316, and electronic components. LiDAR system 300 may include an analyzer 314 with elements such as processor 322 and non-transitory computer-readable memory 320 containing programming instructions that are configured to enable the system to receive data collected by the light detector unit, analyze the data to measure characteristics of the light received, and generate information that a connected system can use to make decisions about operating in an environment from which the data was collected. Analyzer 314 may be integral with the LiDAR system 300 as shown, or some or all of analyzer 314 may be external to LiDAR system 300 and communicatively connected to LiDAR system 300 via a wired and/or wireless communication network or link.

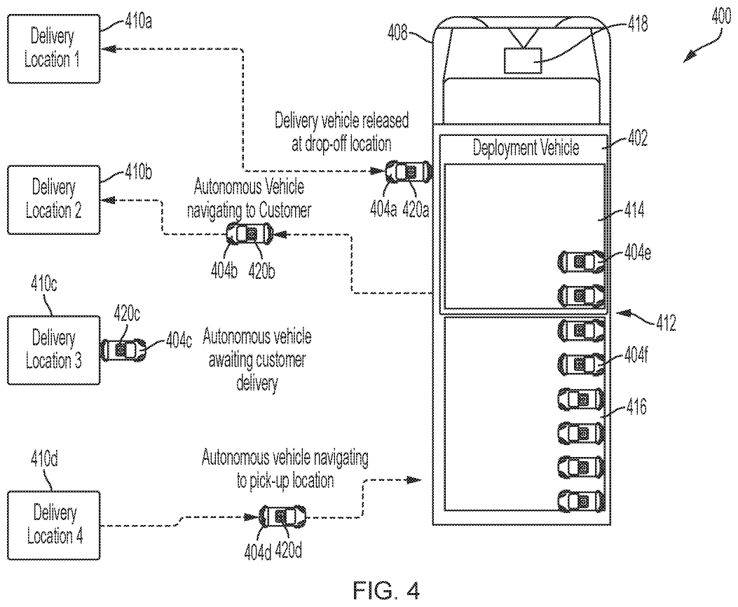

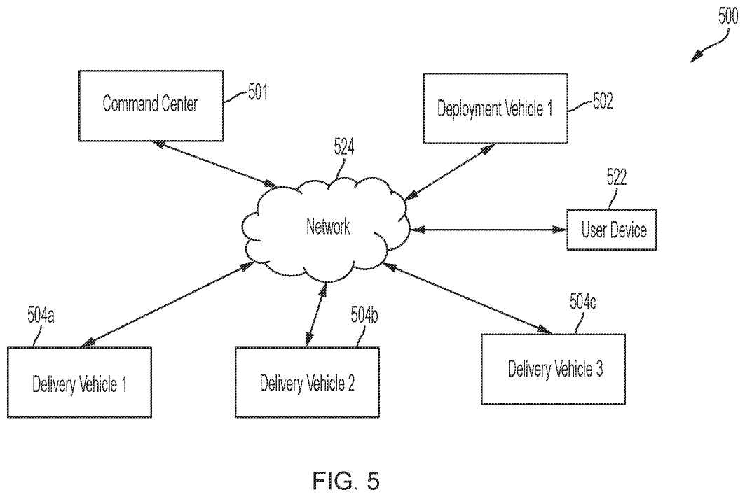

With respect to FIGS. 4-11, element numbers bearing the same two final digits may have the same or similar characteristics unless explicitly specified to the contrary. For example element 402 from FIG. 4 may have the same or similar characteristics as element 502 from FIG. 5.

Referring to FIG. 4, a delivery system 400 is shown according to non-limiting embodiments or aspects. The delivery system 400 may include a deployment vehicle 402, and the deployment vehicle 402 may contain a plurality of autonomous delivery vehicles 404, each securing a package to be delivered. The package may comprise a good itself and/or the good packaged in shipping material. The deployment vehicle 402 may deploy from a distribution location (not shown) to a deployment location 408 to deploy an autonomous delivery vehicle 404a-f from the deployment location 408 to a delivery location 410a-d.

The distribution location may be a location at which packages are secured to delivery vehicles 404a-f and a location at which the delivery vehicles 404a-f are loaded onto deployment vehicles 402. The distribution location may be a location at which the deployment vehicles 402 are deployed to the deployment location 408. The distribution location may be a store, a distribution center, a manufacturing plant, an intermediary routing center, or some combination thereof.

The deployment location 408 may be a location at which delivery vehicles 404a-f are deployed from the deployment vehicle 402 to navigate to the delivery location 410a-d. The deployment location 408 may be a location proximate to the delivery location 410a-d, such as closer to the delivery location 410a-d than the distribution location. The deployment location 408 may be a location proximate to delivery locations 410a-d to be provided packages by a delivery vehicle 404a-f on the deployment vehicle 402. For example, the deployment location 408 may be street, a neighborhood, a housing plan, industrial park, or some combination or collection thereof.

The delivery location 410a-d may be the location to which the package is to be delivered. For example, the delivery location 410a-d may be a residential location, such as a mail box, a porch, a doorstep, a front door, a back door, a garage door, a driveway, and the like. The delivery location 410a-d may be a commercial location, such as a business mailbox, a business location, and the like.

The deployment vehicle 402 may be a car, van, truck, or the like and may be large enough to contain the plurality of delivery vehicles 404a-f.

The deployment vehicle 402 may be a vehicle operated by a driver to deploy the delivery vehicles 404a-f from the deployment location 408. Alternatively, the deployment vehicle 402 may be an autonomously or semi-autonomously operated vehicle. For example, the deployment vehicle 402 may be AV 102a of FIG. 1 and/or may be equipped with any of the autonomous or semi-autonomous vehicle components described above in connection with FIGS. 1-3 to enable navigation from the distribution location to the deployment location 408. The deployment vehicle 402 may comprise sensors 418 mounted thereto to enable autonomous or semi-autonomous navigation of the deployment vehicle 402, as is described above in connection with FIGS. 1-3.

In some non-limiting embodiments or aspects, the sensors 418 may comprise a location system that enables the deployment vehicle 402 to sense its geographical location. For example, the location system may comprise a global position system (GPS) for sensing location of the deployment vehicle 402, although it will be appreciated that any other form of location system may be included on the deployment vehicle 402.

In some non-limiting embodiments or aspects, the sensors 418 may additionally or alternatively comprise a navigation sensor that enables the deployment vehicle 402 to navigate to the deployment location 408 and to identify objects in the path of the deployment vehicle 402 and take a corrective action to avoid the objects and navigate to the deployment location 408. Corrective actions may include an acceleration, a deceleration, a change of direction, and the like. The navigation sensor may comprise a camera, LiDAR, or other suitable object detection device, such as is described above in connection with FIGS. 1-3.

Using the sensors 418, such as the location system and/or the navigation sensors, the deployment vehicle 402 may autonomously or semi-autonomously navigate from the distribution location to the deployment location 408.

The deployment vehicle 402 may have an interior comprising a docking bay 412. The docking bay 412 may be a location inside the deployment vehicle 402 configured to store delivery vehicles 404a-f. The docking bay 412 may be a location to securely hold the delivery vehicles 404a-f until they are deployed to the delivery location 410a-d and/or after they return therefrom. The docking bay 412 may be a location at which the energy supply of the delivery vehicles 404a-f may be replenished, such as by charging with electricity or filling with gasoline, depending on the configuration of the delivery vehicles 404a-f.

The docking bay 412 may have a deployment bay 414 and a collection bay 416. The deployment bay 414 may be a section of the docking bay 412 containing delivery vehicles 404e ready to be deployed to a delivery location 410. The collection bay 416 may be a section of the docking bay 412 containing delivery vehicles 404f that have returned from the delivery location 410 and have been collected by the deployment vehicle 402.

The deployment vehicle 402 may comprise a ramp (not shown) or other mechanism to enable the delivery vehicles 404a-f to automatically deploy from or board the deployment vehicle 402. For example, the delivery vehicles 404a-f may drive up or down the ramp of the deployment vehicle 402 to move from the inside of the docking bay 412 to the ground (and vice versa).

With continued reference to FIG. 4, delivery vehicles 404a-f may deploy from the deployment vehicle 402 at the deployment location 408 to delivery locations 410a-d and return to the same or different deployment vehicle 402 at a collection location (not shown), which may be the same or different from the deployment location 408. The delivery vehicles 404a-f are shown at different stages in the process, which will be described herein.

Each delivery vehicle 404a-f may comprise a sensor set 420a-d that includes at least one sensor for enabling autonomous navigation of the delivery vehicle 404a-f from the deployment location 408 to the corresponding delivery location 410a-d. In FIG. 4, sensor sets are illustrated as 420a-d on, respectively, delivery vehicles 404a-d. However, it would be understood that all delivery vehicles 404, including delivery vehicles 404e-f of FIG. 4, may include a sensor set. Any suitable number, type, and arrangement of sensors may form the sensor set 420a-d that may be mounted on the delivery vehicles 404a-f to enable autonomous navigation thereof. For example, each delivery vehicle 404a-f may be equipped with any of the autonomous or semi-autonomous vehicle sensors described above in connection with FIGS. 1-3 to enable navigation from the deployment location 408 to the delivery location assigned to that delivery vehicle.

In some non-limiting embodiments or aspects, the sensor sets 420a-d may comprise a location system that enables the delivery vehicle 404a-f to sense its geographical location. For example, the location system may comprise a global navigation satellite system (GNSS), for example a global positioning system (GPS), for sensing location of the delivery vehicle 404a-f, although it will be appreciated that any other form of location system may be included on the delivery vehicle 404a-f.

In some non-limiting embodiments or aspects, the sensor sets 420a-d may additionally or alternatively comprise a navigation sensor that enables the delivery vehicle 404a-f to navigate to the appropriate delivery location and to identify objects in the path of the delivery vehicle 404a-f and take a corrective action to avoid the objects and navigate to the delivery location. Corrective actions may include an acceleration, a deceleration, a change of direction, and the like. The navigation sensor may comprise a camera, LiDAR, or other suitable object detection device.

In some non-limiting embodiments or aspects, the delivery vehicles 404a-f may receive location data from the deployment vehicle 402 in order to autonomously navigate to the delivery location 410a-d. For example, the deployment vehicle 402 may communicate its current location, including position and/or heading, to the delivery vehicles 404a-f at the time the delivery vehicles 404a-f are deployed from the deployment vehicle 402 to the delivery locations 410a-d. Having received this current location data from the deployment vehicle 402, the delivery vehicle 404a-f may use that location data in conjunction with its sensor sets 420a-d and other stored navigation data to autonomously navigate to the delivery locations 410a-d. The sensor sets 420a-d used in conjunction with the location data from the deployment vehicle 402 may include cameras and/or LiDAR. The other stored navigation data may include maps stored by the delivery vehicles 404a-f corresponding to the area to be navigated by the delivery vehicles 404a-f to get from the deployment vehicle 402 to the delivery locations 410a-d.

Using the sensor sets 420a-d, such as the location system and/or the navigation sensors, the delivery vehicle 404a-f may autonomously or semi-autonomously navigate from the deployment vehicle 402 to the appropriate delivery location.

With reference to FIG. 4, a first delivery vehicle 404a may be programmed or configured to deploy from the deployment vehicle 402 at the deployment location 408, in order to automatically deliver the secured package contained within first delivery vehicle 404a to a first delivery location 410a. First delivery vehicle 404a may use sensor set 420a to navigate from deployment location 408 to first delivery location 410a.

A second delivery vehicle 404b may be en route from the deployment vehicle 402 to a second delivery location 410b, in order to automatically deliver the secured package contained within the second delivery vehicle 404b to the second delivery location 410b.

The second delivery vehicle 404b may be programmed or configured to autonomously navigate from the deployment vehicle 402 to the second delivery location 410b using sensor set 420b.

A third delivery vehicle 404c may have successfully autonomously navigated from the deployment vehicle 402 to a third delivery location 410c using sensor set 420c and may be programmed or configured to park at the third delivery location 410c, as illustrated in FIG. 4. Parking the third delivery vehicle 404c may comprise stopping the third delivery vehicle 404c at the third delivery location 410c. While parked at the third delivery location 410c, the third delivery vehicle 404c may execute a “chest mode” operation in which the third delivery vehicle 404c is parked at the third delivery location 410c while securing the package. In the chest mode, the package may be secured to the third delivery vehicle 404c such that it cannot be released therefrom until an authorization protocol (described herein) has been satisfied. The third delivery vehicle 404c may remain parked at the third delivery location 410c until the secured package is released to the user (e.g., recipient of the package) via the authorization protocol or until after the expiration of a time period during which the authorization protocol is not satisfied at which time the third delivery vehicle 404c can return, with the package still intact, to the collection location.

A fourth delivery vehicle 404d, having delivered its package to the fourth delivery location 410d, may be programmed or configured to then autonomously navigate from a fourth delivery location 410d to a collection location (shown as being the same as the deployment location 408 in this non-limiting example). In response to the fourth delivery vehicle 404d releasing the package at a fourth delivery location 410d (e.g., in response to the authorization protocol being satisfied), the fourth delivery vehicle 404d may autonomously navigate from the fourth delivery location 410d to the collection location. Alternatively, in response to the expiration of a time period during which the package was not released (e.g., the authorization protocol not being satisfied), the fourth delivery vehicle 404d may autonomously navigate from the fourth delivery location 410d to the collection location. The fourth delivery vehicle 404d may autonomously navigate from the fourth delivery location 410d to the collection location using sensor set 420d in the same manner as was describe in connection with the second delivery vehicle 404b and sensor set 420b. The fourth delivery vehicle 404b may receive coordinates (such as from a command center (not shown)) associated with the collection location and autonomously navigate to the collection location in response to receiving coordinates thereto. The fourth delivery vehicle 404d may receive the coordinates in response to the package being released or in response to the expiration of the time period during which the package was to be authorized for release. In the embodiment in which the authorization protocol was not satisfied before the expiration of the time period, the fourth delivery vehicle 404d may still have the package secured when returning to the collection location.

A fifth delivery vehicle 404e is shown in FIG. 4 in the deployment bay 414. The fifth delivery vehicle 404e may have a package secured thereto and be waiting in the deployment bay until being deployed to autonomously navigate to a fifth delivery location (not shown) to deliver the secured package.

A sixth delivery vehicle 404f is shown in FIG. 4 in the collection bay 416. The sixth delivery vehicle 404f may have returned from being deployed to a sixth delivery location (not shown), and may have been collected by the deployment vehicle 402. The deployment vehicle 402 may be the same deployment vehicle 402 that deployed the sixth delivery vehicle 404f to the sixth delivery location. However, as explained further below, the deployment vehicle 402 may be a different deployment vehicle 402 than the deployment vehicle 402 that deployed the sixth delivery vehicle 404f to the sixth delivery location. The sixth delivery vehicle 404f may be programmed or configured to automatically board the deployment vehicle 402 (e.g., by the ramp) at the collection location. The sixth delivery vehicle 404f may be stored in the collection bay 416 and may be returned to the distribution location by the deployment vehicle 402.

With continued reference to FIG. 4, the deployment vehicle 402 may comprise a plurality of delivery vehicles 404a-f arranged therein (e.g., in the docking bay 412), and each of the delivery vehicles 404a-f may be configured to autonomously navigate to a different delivery location 410a-d. For example, the first delivery vehicle 404a may autonomously navigate to the first delivery location 410a and the second delivery vehicle 404b may autonomously navigate to the second delivery location 410b different from the first delivery location 410a. The first delivery vehicle 404a may autonomously navigate from the first delivery location 410a to a first collection location, and the second delivery vehicle 404b may autonomously navigate from the second delivery location 410b to a second collection location, which may be the same or different from the first collection location.

Further, while FIG. 4 shows a single deployment vehicle 402, the delivery system 400 may comprise a plurality of deployment vehicles, each containing a plurality of delivery vehicles and configured to navigate to different deployment locations.

Referring to FIG. 5, a delivery system 500 is shown according to non-limiting embodiments or aspects. The delivery system 500 may comprise a command center 501, a first deployment vehicle 502, a plurality of delivery vehicles 504a-c, and a user device 522 communicating over a network 524. The network 524 is not particularly limited and may be any suitable public or private communication network 524. The network 524 may be a wireless communication network.

The command center 501 may comprise a computer system programmed or configured to communicate data and instructions over the network 524 to the first deployment vehicle 502 and/or the delivery vehicles 504a-c. For example, the command center 501 may communicate a map of an area to be navigated by the first deployment vehicle 502 and/or the delivery vehicles 504a-c. The command center 501 may communicate coordinates of a deployment location, re-routing instructions, a delivery location, and/or a collection location to the first deployment vehicle 502 and/or the delivery vehicles 504a-c. The command center 501 may communicate any other type and content of instructions to the first deployment vehicle 502 and/or the delivery vehicles 504a-c to cause the first deployment vehicle 502 and/or the delivery vehicles 504a-c to execute the delivery tasks.

The first deployment vehicle 502 and/or the delivery vehicles 504a-c may communicate with the command center 501. For example, the first deployment vehicle 502 and/or the delivery vehicles 504a-c may communicate status updates to the command center 501, such as updates about the first deployment vehicle's 502 and/or the delivery vehicles' 504a-c location or progress. The first deployment vehicle 502 and/or the delivery vehicles 504a-c may communicate requests for instructions to the command center 501 to cause the command center 501 to generate and communicate instructions to the first deployment vehicle 502 and/or the delivery vehicles 504a-c. The first deployment vehicle 502 and/or the delivery vehicles 504a-c may communicate a help message to the command center 501 as described herein.

The command center 501 may communicate over the network 524 with the user device 522. The user device may be a computing device of a user, such as an individual receiving a package. The command center 501 may communicate a status update to the user device 522, in order to provide the user device 522 with an update regarding the delivery of the user's package. Such updates may include a location of the package, an expected delivery date or time, the occurrence of the deployment of the package from the distribution center or the deployment vehicle 502, instructions for authorizing the package for release once the delivery vehicle 504a arrives at the delivery location, and the like. The user device 522 may communicate with the command center 501. For example, the user device 522 may communicate a status request to the command center 501, so as to cause the command center 501 to return an update. The user device 522 may communicate instructions to the command center 501 associated with the delivery of the package. For example, such instructions may cancel the delivery, change the requested delivery location or time, provide or change drop off instructions, and the like.

With continued reference to FIG. 5, the first deployment vehicle 502 and the delivery vehicles 504a-c may communicate over the network 524. The first deployment vehicle 502 may communicate instructions to a delivery vehicle 504a, such as instructions to deploy from the deployment vehicle 502, instructions to return to the deployment vehicle 502, and the like. The first deployment vehicle 502 may communicate location and/or navigation instructions to the delivery vehicle 504a, such as a delivery location, a present location of the first deployment vehicle 502 (e.g., a collection location), a future location of the first deployment vehicle 502 (e.g., a collection location), and the like. In the event delivery vehicles 504a-c are stored within deployment vehicle 502, this communication between deployment vehicle 502 and delivery vehicles 504a-c can be in the form of a short range communication (e.g., Bluetooth) or through a wired connection. For example, first deployment vehicle 502 can receive instructions from command center 501 through a wireless, e.g., cellular, communication link and then these instructions can be communicated from first deployment vehicle 502 to the delivery vehicles 504a-c over a different, e.g., Bluetooth, communication link.

The delivery vehicle 504a may communicate instructions to the first deployment vehicle 502, such as instructions to enable deployment from the deployment vehicle 502 (e.g., lower the ramp), instructions to enable boarding on the deployment vehicle 502, and the like. The delivery vehicle 504a may communicate location and/or navigation instructions to the first deployment vehicle 502, such as a present or future location of the delivery vehicle 504a. The delivery vehicle 504a may communicate status updates to the first deployment vehicle 502 (e.g., en route to delivery location, parked at delivery location, returning to collection location, and the like).

The first deployment vehicle 502 may communicate over the network 524 with the user device 522. The first deployment vehicle 502 may communicate a status update to the user device 522, in order to provide the user device 522 with an update regarding the delivery of the user's package. Such updates may include a location of the package, an expected delivery date or time, the occurrence of the deployment of the package from the distribution center or the deployment vehicle 502, instructions for authorizing the package for release once the delivery vehicle 504a arrives at the delivery location, and the like. The user device 522 may communicate with the first deployment vehicle 502. For example, the user device 522 may communicate a status request to the first deployment vehicle 502, to cause the first deployment vehicle 502 to return an update. The user device 522 may communicate instructions to the first deployment vehicle 502 associated with the delivery of the package. For example, such instructions may cancel the delivery, change the requested delivery location or time, provide or change drop off instructions, and the like.

The delivery vehicle 504a may communicate with the user device 522. The delivery vehicle 504a may communicate a status update to the user device 522, in order to provide the user device 522 with an update regarding the delivery of the user's package. Such updates may include a location of the package, an expected delivery date or time, the occurrence of the deployment of the package from the distribution center or the deployment vehicle 502, instructions for authorizing the package for release once the delivery vehicle 504a arrives at the delivery location, and the like. The user device 522 may communicate with the delivery vehicle 504a. For example, the user device 522 may communicate a status request to the delivery vehicle 504a, to cause the delivery vehicle 504a to return an update. The user device 522 may communicate instructions to the delivery vehicle 504a associated with the delivery of the package. For example, such instructions may cancel the delivery, change the requested delivery location or time, provide or change drop off instructions, and the like.

Two delivery vehicles 504a-b may communicate over the network with one another. For example, the delivery vehicles 504a-b may communicate present or future location data, route or re-route data, a status update, and the like.

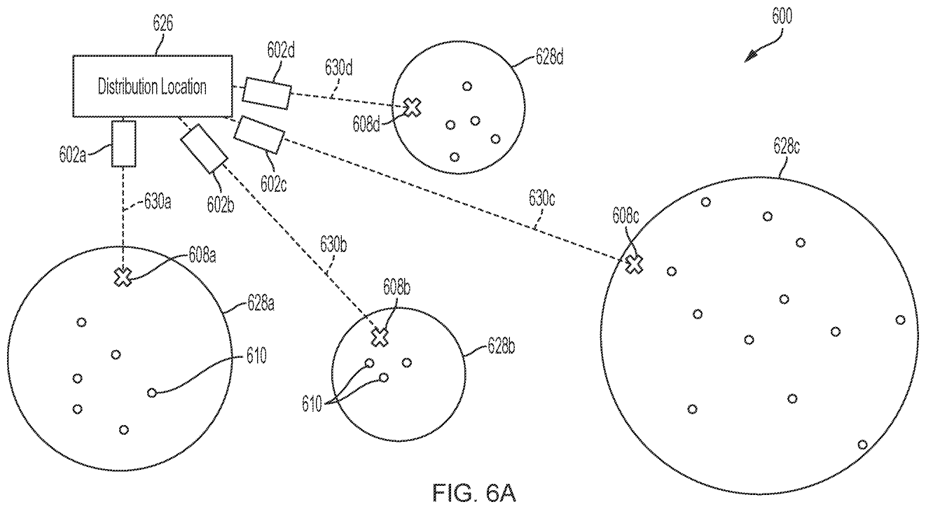

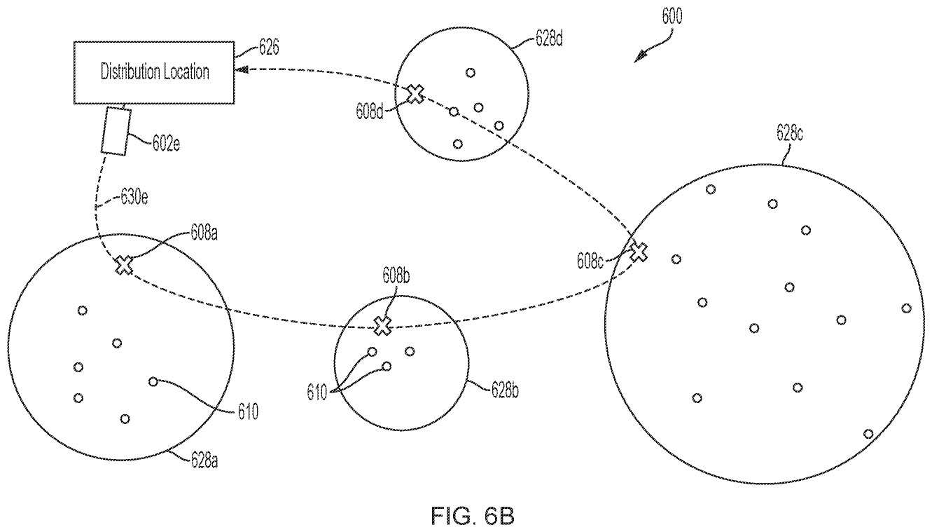

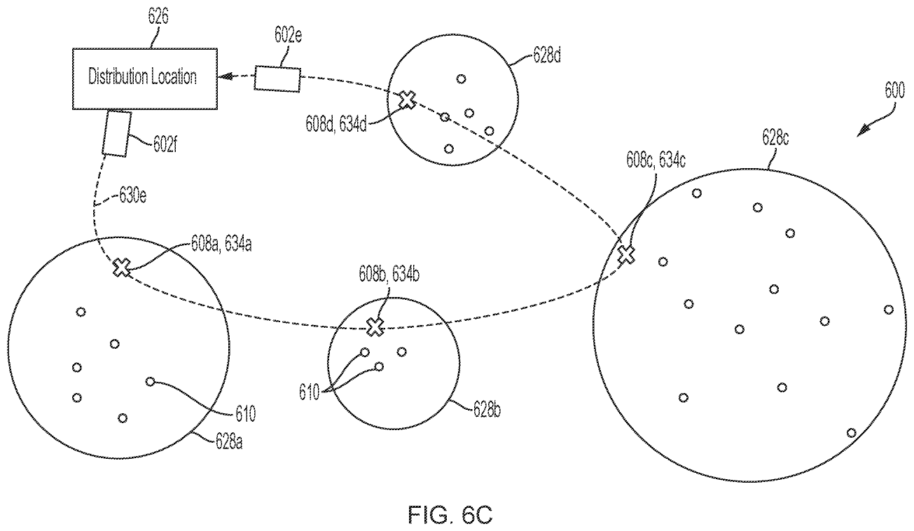

Referring to FIG. 6A, a map 600 of paths taken by delivery systems is shown according to non-limiting embodiments or aspects. FIG. 6 shows a plurality of deployment vehicles 602a-d being deployed from a distribution location 626 to different deployment areas 628a-d. Each deployment area 628a-d is defined as a geographic region inside which the delivery locations 610 (small circles) to be covered by a given deployment vehicle 602a-d are located. For example, the first deployment area 628a contains six delivery locations 610, while the second deployment area 628b contains three delivery locations. The command center (from FIG. 5) may define the deployment areas 628a-d based on the outstanding packages to be delivered. The definition of deployment areas 628a-d may take into account factors such as distance to be traveled by deployment and delivery vehicles for a given proposed set of routes, fuel efficiency for a given proposed set of routes, timing requirements for the deliveries, available deployment and delivery vehicles, among other factors. The command center may consider these factors to generate optimized routes. The routes may be optimized using any suitable route optimization algorithm.

Each deployment area 628a-d may comprise a plurality of delivery locations 610 that require delivery of a package. Each deployment area 628a-d may comprise a deployment location 608a-d (marked by an ‘X’), which may be the location at which the deployment vehicles 602a-d deploy their delivery vehicles (not shown) to the various delivery locations. The map shows the paths 630a-d taken by each of the deployment vehicles 602a-d from the distribution location 626 to the deployment location 608a-d (and back). While the paths 630a-d are shown as straight lines, it should be understood that this is an approximation of the actual route travelled by the deployment vehicles 602-d. The actual routes would follow the roadways (in the case of a land vehicle) between the distribution location 626 and deployment locations 608a-d.

As shown in the non-limiting example from FIG. 6A, its map 600 includes four deployment vehicles 602a-d being deployed from the distribution location 626 to four different deployment locations 608a-d in four different deployment areas 628a-d, each taking a different path 630a-d. It will be appreciated that any other number and arrangement of deployment vehicles 602a-d, deployment locations 608a-d, deployment areas 628a-d, and paths 630a-d may be used to deliver the packages to the delivery locations 610 shown in the map.

FIG. 6B shows the map 600 of a different path taken by a delivery system according to non-limiting embodiments or aspects. It will be noted that the delivery locations 610, deployment locations 608a-d, and deployment areas 628a-d are the same as in FIG. 6A, but a different configuration of deployment vehicle 602e and path 630e is used. In this non-limiting example, a single deployment vehicle 602e is used which contains a plurality of delivery vehicles (not shown). The deployment vehicle 602e stops at each of the deployment locations 608a-d in a sequence, in order to deploy a portion of the delivery vehicles it contains to each deployment area 628a. In some non-limiting embodiments, the deployment vehicle 602e may wait at each deployment location 608a-d for the delivery vehicles to return from their deliveries, or the deployment vehicle 602e may continue on to the next deployment location 602a-d, and return at a later time (or let another deployment vehicle return (see FIG. 6C) to collect the delivery vehicles. In this non-limiting example, the deployment vehicle stops at the first deployment location 608a in the first deployment area 628a, followed by the second deployment location 608b in the second deployment area 628b, followed by the third deployment location 608c in the third deployment area 628c, followed by the fourth deployment location 608d in the fourth deployment area 628d, before returning to the distribution location 626. The path 630e followed by the deployment vehicle 602e may be optimized by the command center and, again, is illustrated as an approximation whereas the actual route of path 630e would follow roadways.

FIG. 6C shows the map 600 of the path taken by the delivery system from FIG. 6B, but further includes the path taken by a collection system according to non-limiting embodiments or aspects. It will be noted that the delivery locations 610, deployment vehicle 602e, deployment locations 608a-d, deployment areas 628a-d, and path 630e are the same as in FIG. 6B. In this non-limiting example, the deployment vehicle 602e deployed the delivery vehicles at each of the deployment locations 608a-d and continued on to the next of the deployment locations 608a-d without waiting for the delivery vehicles to return from their delivery locations 610. A collection system may be used in which a second deployment vehicle 602f (hereinafter referred to as the collection vehicle 602f for clarity) may be used. The collection vehicle 602f may have the same or similar features compared to the deployment vehicle 602e.

The collection vehicle 602f may follow the path 630e at a later time (than the deployment vehicle 602e) to collect all or a portion of the delivery vehicles deployed by the deployment vehicle 602e. The path 630e may be the same path as the path 630e followed by the deployment vehicle 602e, or a different path may be used. The collection vehicle 602f may collect previously deployed delivery vehicles at various collection locations 634a-d. In this example, the collection locations 634a-d may be identical to the deployment locations 608a-d; however different collection locations 634a-d may be used in other examples. The path 630e followed by the collection vehicle 602f and the collection locations 634a-d utilized thereby may be optimized by the command center based on the status and location of the various delivery vehicles. The collection vehicle 602f may collect all of the delivery vehicles deployed by the deployment vehicle 602e, or only a subset thereof depending on the delivery status of each of the delivery vehicles. One or more collection vehicles 602f may also be used in the configuration of FIG. 6A, wherein one or more of the deployment vehicles 602a-d returns to the distribution location 626 without its delivery vehicles and one or more collection vehicles 602f (which may be the same as the deployment vehicles 602a-d) are then deployed to collect the delivery vehicles.

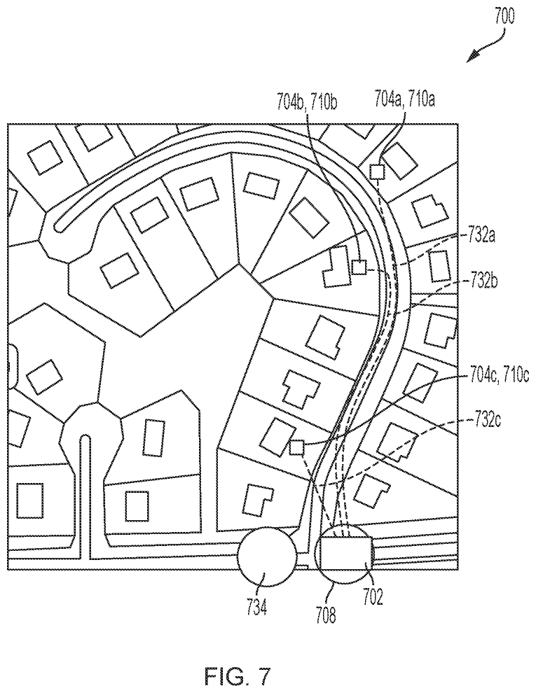

Referring to FIG. 7 a map 700 of paths taken by delivery vehicles is shown according to non-limiting embodiments or aspects. The map 700 may include a street map showing a deployment vehicle 702 deploying delivery vehicles 704a-c at a deployment location 708. In this non-limiting example, the deployment location 708 is the beginning of a neighborhood having a plurality of residential homes, and in this example, the neighborhood includes 3 houses requiring the delivery of a package. The deployment vehicle 702 may deploy the delivery vehicles 704a-c at the deployment location 708, and the delivery vehicles 704a-c may autonomously navigate to their respective delivery locations 710a-c. The map 700 shows the paths 732a-c taken by each of the delivery vehicles 704a-c to autonomously navigate to their respective delivery locations 710a-c.

With continued reference to FIG. 7, the map 700 further specifies a collection location 734, which is different from the deployment location 708 (although the collection location 734 and the deployment location 708 may be the same). After releasing their packages at the delivery location 710a-c or after expiration of the time period, the delivery vehicles 704a-c may autonomously navigate to the collection location 734 to be collected by the same or different deployment vehicle 702. The delivery vehicles 704a-c may receive coordinates and/or instructions associated with navigating to the collection location 734 after releasing their packages at the delivery location or after expiration of the time period (e.g., from the command center of FIG. 5).

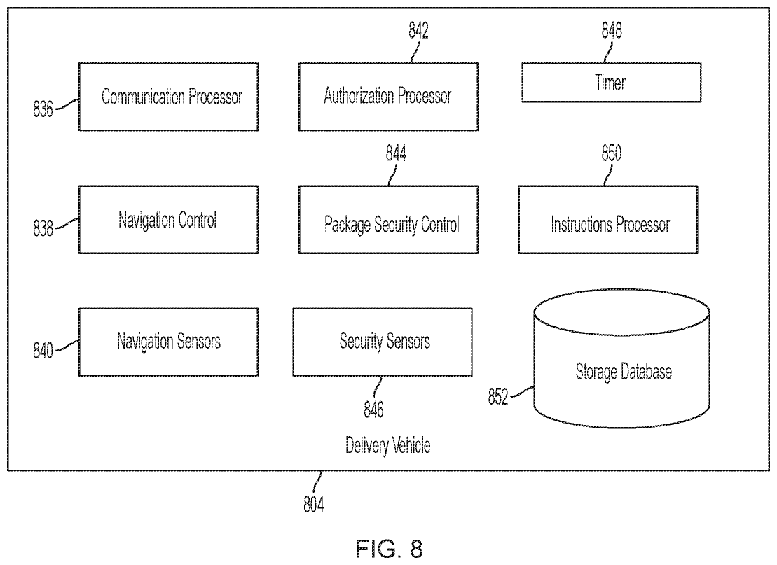

Referring to FIG. 8, a delivery vehicle 804 is shown according to non-limiting embodiments or aspects. The delivery vehicle 804 may comprise a plurality of components that enable the delivery vehicle 804 to execute the tasks described herein. Each of the components of the delivery vehicle 804 shown in FIG. 8 are illustrated (and described herein) as separate computing components. However, it will be appreciated that one or more of these components may be further subdivided into other components, or one or more of these components may be combined with another component to form a single component executing the function of both separately described components.

The delivery vehicle 804 may comprise a communication processor 836. The communication processor 836 may enable the delivery vehicle 804 to communicate with other components of the delivery system, such as over the network 524 shown and described in FIG. 5. For example, the communication processor 836 may receive instructions from the command center. The communication processor 836 may send updates and help requests to the command center. The communication processor 836 may send and receive instructions or otherwise communicate with other delivery vehicles, with deployment vehicles, with user devices, and the like. The communication processor 836 may wirelessly communicate with these various other components of the delivery system.

The delivery vehicle 804 may comprise a navigation control 838. The navigation control 838 may cause the delivery vehicle 804 (e.g., components thereof) to move. For example, the navigation control 838 may cause the wheels, motor, brakes (not shown) of the delivery vehicle 804 to execute the actions necessary to autonomously navigate the delivery vehicle 804 to its next destination (e.g., the delivery location or the collection location). The navigation control 838 may co-act with the navigation sensors 840 described herein to navigate the delivery vehicle 804 in response to signals received by the navigation sensors 840. The navigation control 838 may also co-act with the storage database 852 to retrieve data stored thereon associated with navigating the delivery vehicle 804. For example, the navigation control 838 may retrieve a map and/or route data stored in the storage database 852.

The delivery vehicle 804 may comprise navigation sensors 840. The navigation sensors 840 may include the same or similar features as the sensor sets 420a-d shown and described in connection with FIG. 4. The navigation sensors 840 may sense the surroundings of the delivery vehicle 804 to assist in the delivery vehicle's autonomous navigation. The navigation sensors 840 may include at least one image sensor to detect objects in the surroundings of the delivery vehicle 804. The navigation sensors 840 may comprise at least one location sensor to sense a geographic location of the delivery vehicle 804. The navigation sensors 840 may transmit their sensed data to the navigation control 838 to assist in the navigation of the delivery vehicle 804.

The delivery vehicle 804 may comprise an authorization processor 842. The delivery vehicle 804 may secure a package for delivery. In response to the authorization protocol being satisfied, the delivery vehicle 804 may release the package. The authorization processor 842 may execute this authorization protocol, which may release the secured package to the verified user at the delivery location. The authorization protocol executed by the authorization processor 842 may be any protocol suitable for ensuring that the package is only being released to an authorized user. The authorization processor 842 may communicate a signal to the hardware securing the package to release the package upon the satisfaction of the authorization protocol.

For example, in some non-limiting embodiments, the authorization protocol may comprise a short-range wireless communication between a user device and the delivery vehicle 804, such as the communication processor 836 and/or authorization processor 842, which verifies that the user is in the vicinity of the delivery vehicle 804 such that the package can be released to the correct user. Non-limiting examples of short-range communication protocols suitable for this application include radio frequency identification (RFID), near field communication (NFC), Bluetooth, and the like. Therefore, proximate arrangement of the user device with the delivery vehicle 804 to enable short-range wireless communication therebetween may satisfy the authorization protocol.

In another non-limiting example, an access code may be transmitted to the user device, and the user device may use the access code to satisfy the authorization protocol. This may include the user device transmitting a message containing the access code to the communication processor 836 and/or authorization processor 842 at a given time to release the package. This may include entering the access code into a keypad of the delivery vehicle 804 (an example of a package security control 844) to release the package. With reference to FIG. 5, the access code may have been delivered to the user device 522 from a command center 501 over a network 524.

In another non-limiting example, the authorization protocol may comprise a biometric sensor, e.g., fingerprint, retinal, and/or face scanner that enables the user to authorize release of the package. The user's biometric data may be stored (e.g., by the storage database 852), and the stored biometric data may be compared to the biometric input the user enters to the delivery vehicle 804. A match therebetween may release the package.

It will be appreciated that any other protocol for verifying the proximity of the user to the delivery vehicle 804, such that the package can be securely released to the user, may be implemented as the authorization protocol.

The delivery vehicle 804 may comprise a package security control 844. The package security control 844 may comprise the mechanisms controlled by the authorization processor 842 to release the package. The authorization processor 842 may cause the package security control 844 to release when the authorization protocol has been satisfied. The package security control 844 may comprise a keypad for a user to enter an access code as previously described. The package security control 844 may comprise a lock to a container of the delivery vehicle 804 which is not released until the authorization protocol is satisfied. The package security control 844 may include a biometric scanner to release the package in response to receiving matching biometric data from the user. The package security control 844 may be any other hardware security mechanism that prevents the package from being released prior to satisfaction of the authorization protocol.

The package security control 844 may also be used to react to a trigger action indicating a potential emergency situation encountered by the delivery vehicle 804. The package security control 844 may detect trigger actions using security sensors 846 of the delivery vehicle 804. The delivery vehicle 804 may comprise security sensors 846. The security sensors 846 may comprise the same or similar features as the sensor set 420a-d shown and described in connection with FIG. 4. The security sensors 846 may be the same or different from the navigation sensors 840. The security sensors 846 may have a distinguishable function from the navigation sensors 840 (even if they are the same physical sensors). The security sensors 846 may be mounted to the delivery vehicle 804 to provide security to the delivery vehicle 804 and the package secured thereby. The security sensors 846 may detect a potential emergency situation by the data collected.

The security sensors 846 and the package security control 844 may detect trigger actions indicating a potential emergency situation encountered by the delivery vehicle 804. The delivery vehicle 804 may be programmed or configured to detect any potential emergency situation. Non-limiting examples of trigger actions include detecting the delivery vehicle 804 being picked up off of the ground (e.g., an unintended user attempting to run off with the delivery vehicle 804 and/or the package), detecting the package being released without the authorization protocol being satisfied (e.g., an unintended user attempting to force the release of the package), a power level of the delivery vehicle 804 falling below a threshold (e.g., indicting a lower power level of the delivery vehicle 804), or the delivery vehicle being stuck (e.g., from being lost, failing to properly navigate an obstacle, being in a disabling collision, falling into a hole, and the like).

The security sensors 846 may comprise an image sensor positioned to sense images of the surroundings of the delivery vehicle 804, to capture audio/visual data indicating a potential trigger action against the delivery vehicle 804.

The security sensors 846 may comprise an audio sensor to sense sounds of the surroundings of the delivery vehicle 804 that may indicate a potential trigger action against the delivery vehicle 804.

The security sensors 846 may comprise a location sensor to sense a location of the delivery vehicle 804, and a potential difference between the actual and intended location of the delivery vehicle 804.

The security sensors 846 may include any other type of sensor (e.g., gyroscope, accelerometer, and the like) which may detect a potential trigger action against the delivery vehicle 804.

In response to the security sensors 846 sensing the occurrence of a trigger action, the package security control 844 may generate a help message that indicates the delivery vehicle 804 being in need of assistance. The help message may comprise data, including data collected by the security sensors 846 that provides details about the trigger action event encountered by the delivery vehicle. The help message may comprise location data corresponding to the distressed delivery vehicle 804. The communication processor 836 and/or the package security control 844 may communicate the help message, such as to the command center (from FIG. 5). The command center may then take further action to address the trigger action. Such further action may include alerting the proper authorities (e.g., the police department) or deploying a deployment vehicle to retrieve the distressed delivery vehicle. In response to the help message, the command center may communicate instructions to the communication processor 836 to cause the delivery vehicle 804 to take a corrective action to address the trigger action. For example, the correction action may comprise sounding an audible and/or visible alarm on the delivery vehicle 804.

The delivery vehicle 804 may comprise a timer 848. The timer 848 may time the duration the delivery vehicle 804 sits parked at a delivery location. After expiration of a time period during which the authorization protocol must be satisfied (based on the timer 848), the delivery vehicle 804 may autonomously navigate from the delivery location to the collection location with the package still secured.

The delivery vehicle 804 may comprise an instructions processor 850. The instructions processor 850 may process instructions received from other components of the delivery system. For example, the delivery vehicle 804 may receive instructions from the command center, the deployment vehicle, another delivery vehicle, and/or the user device. The instructions processor 850 may process these instructions and determine the component(s) of the delivery vehicle 804 relevant for executing those instructions. The instructions processor 850 may transmit the instructions to the relevant components to cause the relevant components to execute the instructions.

The delivery vehicle 804 may comprise a storage database 852. The storage database 852 may store data received by the delivery vehicle 804, and the received data may be used to execute functions of the delivery vehicle 804. For example, the storage database 852 may receive and store maps and/or navigation instructions that enable the delivery vehicle 804 to autonomously navigate to the next destination (e.g., delivery location or collection location). The storage database 852 may receive and store data associated with authorizing a user so that the delivery vehicle may release the package in response to satisfaction of the authorization protocol. The storage database 852 may receive and store delivery data associated with delivery of a package (e.g., a delivery location, a delivery time, a user name, and the like). The storage database 852 may receive and store operation instructions that provide the delivery vehicle 804 with rules by which to operate (e.g., how to process instructions, how long to remain parked, and the like).

In some non-limiting embodiments, a single delivery vehicle 804 may contain multiple packages for the same user or for two different users at different delivery locations. For delivery vehicles 804 containing different packages for different users at different delivery locations, the storage database 852 may receive and store data associated with an order in which the packages are to be delivered and the delivery location of each of the packages.

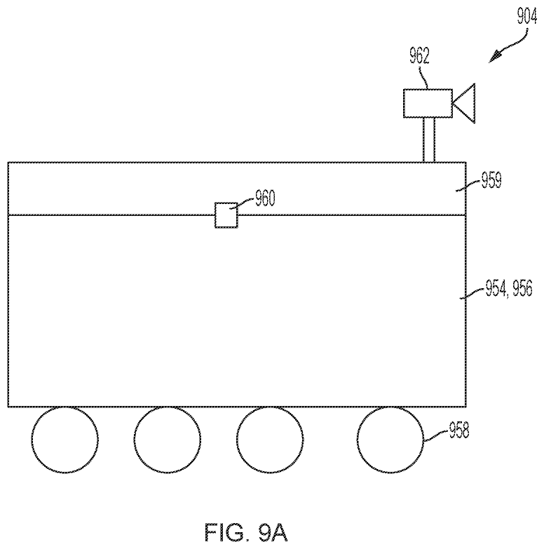

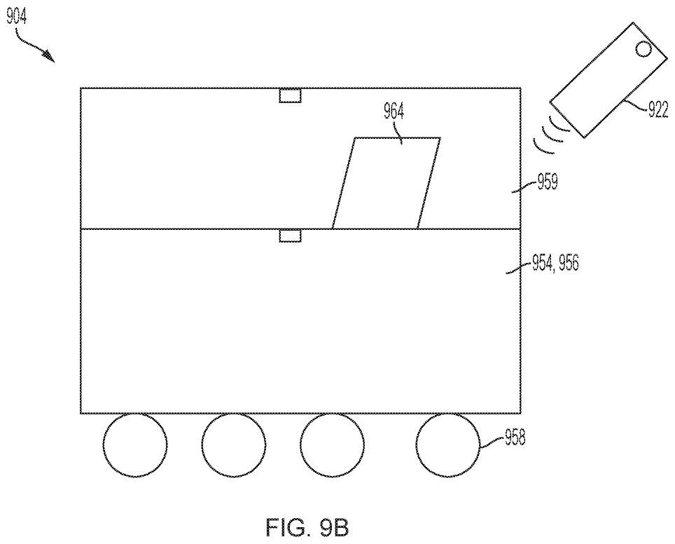

Referring to FIGS. 9A and 9B, a delivery vehicle 904 is shown according to non-limiting embodiments or aspects. The delivery vehicle 904 may comprise a vehicle body 954. The body 954 may comprise a container 956, inside which a package 964 may be stored. The container 956 may be lockable and adapted to secure the package 964. The body 954 may comprise a lid 959 for securely closing the container 956. The body 954 may comprise a securing mechanism 960 for securing the package 964 to the delivery vehicle 904 (e.g., the container 956 may be locked to secure the package 964). In the non-limiting embodiment shown in FIGS. 9A and 9B, the securing mechanism 960 may comprise a latch to secure the lid 959 to the container 956 and keep the package 964 secure to the delivery vehicle 904.

With continued reference to FIGS. 9A and 9B, the delivery vehicle 904 may comprise wheels 958. The wheels 958 may enable movement of the delivery vehicle 904, so that the delivery vehicle 904 may autonomously navigate to its next location. Although shown with wheels 958, it will be appreciated that any other mechanism to allow movement of the delivery vehicle 904 may be employed (e.g., tracks and the like). Further, although the delivery vehicle 904 is shown with components capable of navigating on land, the delivery vehicle may be an aerial drone capable of navigating from the deployment vehicle to the delivery location through the air or may be a water navigating vehicle capable of navigating from the deployment vehicle to the delivery location over water.

The delivery vehicle 904 may also comprise at least one sensor 962. The sensor 962 may include the same or similar characteristics to the navigation sensors 840 and/or the security sensors 846 from FIG. 8. The sensor 962 may enable the delivery vehicle 904 to autonomously navigate or may help with the security of the delivery vehicle 904 and/or the package 964.

Referring to FIG. 9A the delivery vehicle 904 is shown in a secured position with the securing mechanism 960 secured so that the package (in the container 956 and not shown) is secured to the delivery vehicle 904. FIG. 9B shows the delivery vehicle 904 in a released position. In the released position, the securing mechanism 960 has been released so that the lid 959 may be opened and the package 964 removed from the container 956 by the verified user. As shown in FIG. 9B, the locking mechanism 960 may be released by the user device 922 of the verified user being brought into proximate arrangement with the delivery vehicle. Proximate arrangement means that the user device 922 is brought in close enough arrangement that the user device 922 and a component of the delivery vehicle 904 (e.g., communication processor 836 from FIG. 8) communicate with one another using a short-range communication protocol. The user device 922 may communicate with the delivery vehicle 904 according to the authorization protocol to release the package 964.

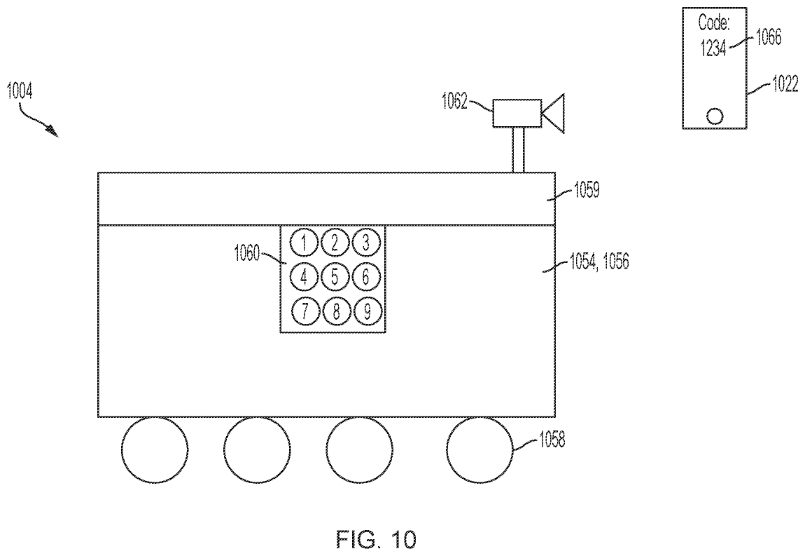

Referring to FIG. 10 another non-limiting embodiment of delivery vehicle 1004 is shown in a secured position with the securing mechanism 1060 secured so that the package (in the container 1056 and not shown) is secured to the delivery vehicle 1004. The securing mechanism 1060 in FIG. 10 may be different from the securing mechanism 960 in certain respects. The securing mechanism 1060 in FIG. 10 may comprise a keypad that enables the user to release the package by inputting the correct access code 1066. As shown in FIG. 10, the user device 1022 may receive the access code 1066 that enables the user to open the securing mechanism 1060 by entering the access code 1066 into the keypad.

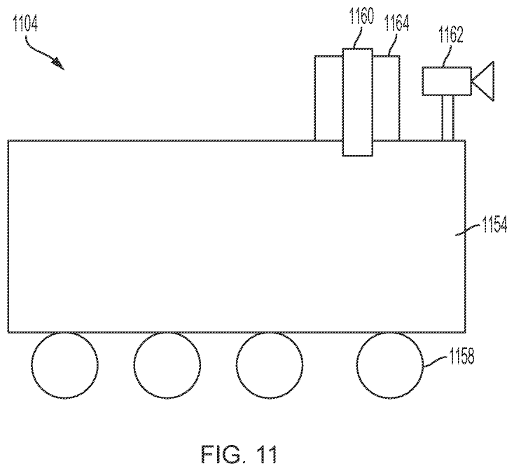

Referring to FIG. 11 another non-limiting embodiment of delivery vehicle 1104 is shown in a secured position with the securing mechanism 1160 secured so that the package 1164 is secured to the delivery vehicle 1104. Compared to FIGS. 9 and 10, the delivery vehicle 1104 may still comprise a body 1154, but the delivery vehicle 1104 may not have a container into which the package 1164 is placed (e.g., no component 956 or 1056 from FIGS. 9 and 10). The package 1164 may be secured to the body 1154 using any suitable means. For example, the package may be secured to the body 1154 and not in a container when the package is of a shape or size not suitable for placement in a container. In this non-limiting example, the securing mechanism 1160 may comprise a strap for securing the package 1164 to the body 1154, but any other securing mechanism capable of securing the package 1164 to the body 1154 until the authorization protocol is satisfied may be employed.

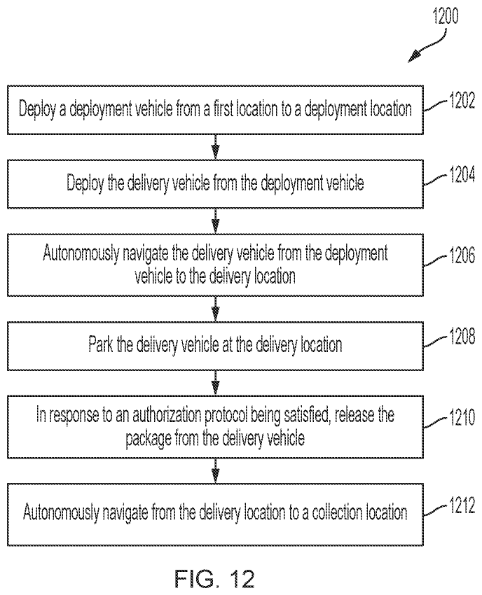

Referring to FIG. 12, a method 1200 is shown for automated delivery according to non-limiting embodiments or aspects. The method 1200 may include a step 1202 of deploying the deployment vehicle from a first location (e.g., a distribution location) to a deployment location. The deployment location may be closer to a delivery location than the first location. The deployment vehicle may contain an autonomous delivery vehicle which secures a package therein. The method 1200 may include a step 1204 of deploying the delivery vehicle from the deployment vehicle. The method 1200 may include a step 1206 of autonomously navigating the delivery vehicle from the deployment vehicle to the delivery location. The method 1200 may include a step 1208 of parking the delivery vehicle at the delivery location. The method 1200 may include a step 1210 of, in response to an authorization protocol being satisfied, releasing the package from the delivery vehicle. The method 1200 may include a step 1212 of the delivery vehicle autonomously navigating from the delivery location to the collection location.

In some non-limiting embodiments or aspects, the present disclosure is also directed to a computer program product for automated delivery. The computer program product may comprise at least one non-transitory computer-readable medium comprising one or more instructions that, when executed by at least one processor, cause the at least one processor to: deploy an autonomous delivery vehicle from a deployment vehicle, wherein the delivery vehicle is arranged within the deployment vehicle, wherein the delivery vehicle secures a package; autonomously navigates the delivery vehicle from the deployment vehicle to a delivery location; parks the delivery vehicle at the delivery location; and in response to an authorization protocol being satisfied, releases the package.

Various embodiments can be implemented, for example, using one or more computer systems, such as computer system 1300 shown in FIG. 13. Computer system 1300 can be any computer capable of performing the functions described herein.

Computer system 1300 can be any well-known computer capable of performing the functions described herein.

Computer system 1300 includes one or more processors (also called central processing units, or CPUs), such as a processor 1304. Processor 1304 is connected to a communication infrastructure or bus 1306.

One or more processors 1304 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1300 also includes user input/output device(s) 1303, such as monitors, keyboards, pointing devices, etc., that communicate with communication infrastructure 1306 through user input/output interface(s) 1302.

Computer system 1300 also includes a main or primary memory 1308, such as random access memory (RAM). Main memory 1308 may include one or more levels of cache. Main memory 1308 has stored therein control logic (i.e., computer software) and/or data.

Computer system 1300 may also include one or more secondary storage devices or memory 1310. Secondary memory 1310 may include, for example, a hard disk drive 1313 and/or a removable storage device or drive 1314. Removable storage drive 1314 may be a floppy disk drive, a magnetic tape drive, a compact disk drive, an optical storage device, tape backup device, and/or any other storage device/drive.

Removable storage drive 1314 may interact with a removable storage unit 1318. Removable storage unit 1318 includes a computer usable or readable storage device having stored thereon computer software (control logic) and/or data. Removable storage unit 1318 may be a floppy disk, magnetic tape, compact disk, DVD, optical storage disk, and/any other computer data storage device. Removable storage drive 1314 reads from and/or writes to removable storage unit 1318 in a well-known manner.

According to an exemplary embodiment, secondary memory 1310 may include other means, instrumentalities or other approaches for allowing computer programs and/or other instructions and/or data to be accessed by computer system 1300. Such means, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1300 may further include a communication or network interface 1324. Communication interface 1324 enables computer system 1300 to communicate and interact with any combination of remote devices, remote networks, remote entities, etc. (individually and collectively referenced by reference number 1328). For example, communication interface 1324 may allow computer system 1300 to communicate with remote devices 1328 over communications path 1326, which may be wired and/or wireless, and which may include any combination of LANs, WANs, the Internet, etc. Control logic and/or data may be transmitted to and from computer system 1300 via communication path 1326.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a deployment vehicle; and
an autonomous delivery vehicle contained within the deployment vehicle, wherein the delivery vehicle is adapted to secure a package therein, wherein the delivery vehicle is programmed or configured to:
deploy from the deployment vehicle;
autonomously navigate from the deployment vehicle to a delivery location;
park at the delivery location; and
in response to an authorization protocol being satisfied, release the package.

2. The system of claim 1, wherein the delivery vehicle is further programmed or configured to:
autonomously navigate from the delivery location to a collection location.

3. The system of claim 2, wherein the delivery vehicle autonomously navigates from the delivery location to the collection location in response to the package being released.

4. The system of claim 2, wherein the delivery vehicle autonomously navigates from the delivery location to the collection location after expiration of a predetermined time period.

5. The system of claim 4, wherein the delivery vehicle retains the secured package at the collection location.

6. The system of claim 2, wherein the delivery vehicle is further programmed or configured to:
automatically board a vehicle at the collection location.

7. The system of claim 6, wherein the vehicle boarded at the collection location is a vehicle other than the deployment vehicle from which the delivery vehicle was deployed.

8. The system of claim 1, wherein the delivery vehicle comprises a location sensor and/or a camera, wherein the delivery vehicle autonomously navigates to the delivery location using the location sensor and/or the camera.

9. The system of claim 1, wherein the delivery vehicle comprises a lockable container adapted to secure the package.

10. The system of claim 1, wherein the authorization protocol comprises a short range wireless communication between a user device and the delivery vehicle to cause the package to be released.

11. The system of claim 2, wherein the delivery vehicle is in wireless communication with a command center.

12. The system of claim 11, wherein the delivery vehicle autonomously navigates to the collection location in response to receiving coordinates for the collection location from the command center.

13. The system of claim 11, wherein the delivery vehicle is further programmed or configured to:
communicate a help message to the command center in response to a trigger action occurring.

14. The system of claim 13, wherein the trigger action comprises at least one of the following:
the delivery vehicle being picked up off the ground;
the package being released without the authorization protocol being satisfied;
a power level of the delivery vehicle falling below a threshold; and/or
the delivery vehicle being stuck.

15. The system of claim 1, wherein a plurality of autonomous delivery vehicles are arranged within the deployment vehicle, comprising a first delivery vehicle and a second delivery vehicle,
wherein the first delivery vehicle is programmed or configured to autonomously navigate to a first delivery location and the second delivery vehicle is programmed or configured to autonomously navigate to a second delivery location different from the first delivery location.

16. The system of claim 15, wherein the first delivery vehicle is further programmed or configured to autonomously navigate from the first delivery location to a first collection location, and the second delivery vehicle autonomously is further programmed or configured to navigate from the second delivery location to a second collection location different from the first collection location.

17. The system of claim 1, wherein the deployment vehicle comprises an autonomous vehicle.

18. The system of claim 17, wherein the deployment vehicle is programmed or configured to autonomously navigate from a first location to a deployment location to deploy the delivery vehicle to the delivery location, wherein the deployment location is closer to the delivery location than the first location.

19. A method comprising:
deploying a deployment vehicle from a first location to a deployment location, wherein the deployment location is closer to a delivery location than the first location, wherein the deployment vehicle contains an autonomous delivery vehicle, wherein the delivery vehicle secures a package therein;
deploying the delivery vehicle from the deployment vehicle;
autonomously navigating the delivery vehicle from the deployment vehicle to the delivery location;
parking the delivery vehicle at the delivery location; and
in response to an authorization protocol being satisfied, releasing the package from the delivery vehicle.

20. A computer program product comprising at least one non-transitory computer-readable medium comprising one or more instructions that, when executed by at least one processor, cause the at least one processor to:
deploy an autonomous delivery vehicle from a deployment vehicle, wherein the delivery vehicle is arranged within the deployment vehicle, wherein the delivery vehicle secures a package;
autonomously navigate the delivery vehicle from the deployment vehicle to a delivery location;
park the delivery vehicle at the delivery location; and
in response to an authorization protocol being satisfied, release the package.
